(19) United States
(12) Patent Application Publication
(10) Pub. No.: US 2018/0365631 A1
(43) Pub. Date: Dec. 20, 2018

(54) ORDER PICKING SYSTEM AND ORDER PICKING METHOD FOR PREPARING AT LEAST A PORTION OF A CORRESPONDING ORDER

(71) Applicant: EXOTEC SOLUTIONS, Lille (FR)

(72) Inventors: Romain Moulin, Paris (FR); Renaud Heitz, Paris (FR)

(21) Appl. No.: 16/060,292

(22) PCT Filed: Dec. 7, 2016
(86) PCT No.: PCT/FR2016/053259

§ 371 Date: Jun. 7, 2018

(30) Foreign Application Priority Data
Dec. 7, 2015 (FR) 15 61931

(51) Int. Cl. G06Q 10/08; G08G 1/00; G05B 19/418

(52) U.S. Cl. CPC G06Q 10/087; G06Q 10/083; G05B 2219/32037; G05B 19/41895; G08G 1/20

(57) ABSTRACT

An order picking system, which includes a plurality of motorised mobile units able to carry containers for receiving one or more products of an order dropped in them by an order picker. The containers have a single product dispensing tray mounted on a base configured so as to elevate the tray at least 60 cm, preferably at least 80 cm. The base includes an interlock with the mobile units and the ground support. Also provided is an order picking method for preparing at least a portion of an order.

### 1. CROSS-REFERENCE TO RELATED APPLICATIONS

This Application is a Section 371 National Stage Application of International Application No. PCT/FR2016/053259, filed Dec. 7, 2016, the content of which is incorporated herein by reference in its entirety, and published as WO 2017/098153 on Jun. 15, 2017, not in English.

### 2. FIELD OF THE INVENTION

The field of the invention is that of warehouse logistics and in particular the handling and transport of parts or products.

More precisely, the invention relates to an order picking system and a corresponding method for preparing at least a portion of a order.

The invention finds application in the automation of flow management of a warehouse preparation and of order shipping.

### 3. STATE OF THE ART

In the global supply chain, flow management and handling products stored within a warehouse play a key role.

Currently, in most logistics warehouses, order pickers move within the warehouse to collect in a tray or crate each product of an order in small quantities on rack shelvings.

Such an organisation causes each order picker to travel long distances during a working day. It also assumes that each order picker has a very good knowledge of the location of products in the warehouse so as to waste time.

To limit the fatigue of the order pickers, to improve the management of the collection of products and to reduce the time and cost of order preparation, it has been suggested to allocate an area of a warehouse to each order picker, where said order picker remains confined. The order picker then moves in the allocated area to pick up a list of products among those being prepared, and then once all the products in the list have been collected, to drop the products in a tray or crate waiting on a conveyor at a station situated near the area allocated to said order picker. Once the list of products has been placed in the collection tray or crate, said tray or crate is transported by the conveyor to an operator responsible for assembling the orders.

A disadvantage of this technique is that the setting up of the conveyor is costly and has large space requirements in the warehouse. This prevents in particular to double or triple the number of “stations” per area to limit the movements of the order pickers.

Another disadvantage of this technique is that conveyors limit the movement of personnel in the warehouse because of their footprint.

It has also been proposed to transport racks placed in the warehouse to an order picking area using robots. For this, a robot is placed under the racks and raises it for transporting purposes.

A disadvantage of this known technique is that the height of the racks must be limited in height, to avoid the tilting of the racks during transport.

### 4. SUMMARY OF THE INVENTION

An aspect of the present invention relates to an order picking system comprising a plurality of motorised mobile units able to carry containers for receiving one or more products of an order dropped in them by an order picker.

According to the invention, said containers have a single product dispensing tray mounted on a base configured so as to elevate the tray at least 60 cm, preferably at least 80 cm, the base comprising interlocking means with the mobile units and ground support means.

Thus, in an unprecedented and particularly smart way, the invention suggests to transport containers that can be dropped on the floor near the products of an order to collect using lightweight robots, so that an order picker can drop the products in a deposit tray.

The tray of the container being located at the working height of the order picker while standing, the latter does not need to bend down to put the product he has just taken on a rack of a shelf in the deposit tray.

In addition, the order picker does not have to transport products or trays during its collection since each container is moved from one position to the next with the help of the motorised mobile units to the products to be collected.

According to a particular embodiment of the invention, said base has a housing configured to allow one of the mobile units to be located beneath the container.

Thanks to these technical characteristics, the mobile units can slip into the housing under the base to lift the container and transport it to a destination. Thus, the gripping of the container by a mobile unit is simplified.

According to an advantageous embodiment of the invention, the ground support means comprise at least 2 feet, preferably at least 3 feet.

Thus, the container is stable when it rests on the ground.

Preferably, the feet are spaced apart enough to allow a mobile unit to slide under the base of the container.

According to a particularly advantageous embodiment of the invention, a unique identifier is associated with each of the containers and the mobile units each comprise means for reading the identifiers.

Each mobile unit can check the identifier of a container autonomously before managing it, which limits the risk of errors in the logistics flow.

Advantageously, in a particular embodiment of the invention, said base is equipped with at least two wheels and/or at least two shoes so as to allow to move the containers on the ground.

The operator can thus push or pull a container parked at an awkward location, such as when the container is in front of a rack and prevents the order picker from reaching a product on a rack. He can also move the container over a short distance to collect several products stored on nearby racks.

In one embodiment particular of the invention, the mobile units each comprise an automatically guided carriage having at least three rolling wheels.

According to an advantageous characteristic of the invention, an order picking system as described above further comprises at least one reservation extending to the ground, formed in a product storage rack, for receiving at least one of the containers.

Thus, the containers do not clutter up the circulation aisles.

One can also provide that the aisles of the warehouse are divided between pedestrian walkways for order pickers, alternating on both sides of the shelvings with circulation aisles dedicated to motorised mobile units. Thus, the order pickers do not cross the path of the mobile units as often as before, which reduces the stress of the order pickers and the necessary vigilance.

According to a particular embodiment of the invention, the order picking system comprises a fixed order picking station where an operator collects the products of an order in said containers transported to the order picking station by the motorised mobile units and places them in a parcel to be shipped.

Thus, the containers are delivered to an order picker in charge of preparing the shipment. Since the transport tasks in the warehouse are automated, the staff can focus exclusively on product picking and shipment preparation.

According to an advantageous embodiment of the invention, at least one of the containers is formed at least partially of a cardboard package of a parcel to be shipped.

Product handling is reduced, because the product simply needs to be fixed solidly in the box before closing it and labelled for shipment. This therefore enables the order picker to save time and to increase the amount of orders shipped.

In addition, it is suggested at the end of the collecting process directly to transfer the portion of the cardboard box to an automatic closing station which closes the cardboard box.

According to a preferred embodiment of the invention, the order picking system further comprises a fleet management module for generating control commands of the movement of mobile units taking into account either the position of mobile units, or simultaneously the position of said mobile units, the position of the containers and the location in the stock of a product of the order to be collected.

According to an advantageous embodiment of the invention, an order picking system as described above comprises a temporary storage area of at least one of the containers.

So, free or waiting containers can be parked in a dedicated area and do not disturb the traffic in the warehouse.

The invention also relates to a method for preparing at least a portion of an order using a plurality of containers and motorised mobile units, said containers having a product deposit tray mounted on a base intended to raise said tray by at least 60 cm, preferably at least 80 cm, and means for interlocking with the mobile units and ground support means, comprising the following steps:

a) selecting a product of said portion of the order to be collected;

b) selecting a container, preferably closest to the product to be collected;

c) selecting a mobile unit comprising a calculation step, for each of the mobile units of the distance to be travelled from its current position to a predetermined position near the ordered product, via the position of the selected container and a step of comparing the calculated travel distances in order to identify the mobile unit to which the travel distance is minimal, that is selected;

d) transporting the container selected by the mobile unit selected in step c) to the predetermined position near the ordered product;

e) notifying an order picker to drop a number n (n≥1) of copies of the ordered product in the selected container;

f) an order picker dropping n copies of the ordered product in the tray of the container;

g) if said order portion comprises a plurality of different products, successively selecting other products of said portion of order and performing steps b) to f) for the other products of said order portion.

h) selecting a mobile unit, comprising a step of calculating, for each of the mobile units of the distance from its current position to a fixed position for the preparation of orders or an automatic cardboard sealing station and a step of comparing the calculated travel distances so as to identify a mobile unit for which the travel distance to the order picking station or the automatic cardboard sealing station is minimal;

i) transporting the container selected by said mobile unit selected in step h) to the order picking station or the automatic cardboard sealing station.

The collection of products is thus automated, depending on the available resources, by moving containers near the products to be collected using the mobile units.

According to an advantageous embodiment of the invention, the predetermined position near the ordered product is located in an aisle, between two racks.

Thus, each container can be moved and placed along the racks closest to the storage location of the goods, without limitation to specific locations. In other words, the result is a “continuous station”.

According to a particular embodiment of the invention, the predetermined position near the ordered product is located at the end of a rack.

According to an advantageous embodiment of the invention, using the transporting step d) or i), the selected mobile unit circulates, at least during a portion of the duration of said transporting step, in a counter-aisle, parallel to an aisle which an order picker is situated, between two racks for storing products.

The motorised mobile units move thus primarily in traffic aisles which are reserved for them while order pickers are moving in pedestrian aisles. Traffic aisles and pedestrian aisles meet on shared traffic arteries between the order pickers and the motorised mobile units.

According to a particular embodiment of the invention, during the transporting step d) or i), the selected mobile unit circulates, for at least a portion of the duration of said transporting step, under and/or through a rack.

### 5. LIST OF FIGURES

Other features and advantages of the invention will become evident on reading the following description of one particular embodiment of the invention, given by way of illustrative and non-limiting example only, and with the appended drawings among which:

FIG. 1 is a schematic perspective view of a warehouse equipped with an exemplary embodiment of an order picking system according to the invention;

FIG. 2 is a schematic perspective representation of the order picking system illustrated with reference to FIG. 1;

FIG. 3 is a perspective schematic representation of a motorised mobile unit and a container used in the warehouse illustrated in FIG. 1;

FIG. 4 is a representation of the motorised mobile unit presented with reference to FIG. 3, transporting the container;

FIG. 5 is a diagrammatic representation of a logistic system for assisting order preparation by implementing an order picking system according to the invention;

FIG. 6 is a block diagram representation of the steps of a management method of an order picking system according to the invention;

FIG. 7 is a perspective schematic perspective view of a warehouse equipped with an exemplary embodiment of an order picking system according to the invention;

FIG. 8 is another perspective, detailed view of the warehouse according to FIG. 7, showing a reservation in a rack for parking containers;

FIG. 9 is a schematic perspective view of another exemplary embodiment of an order picking system according to the invention;

FIG. 10 is a schematic representation, in block diagram form, of the steps of a method for order picking management implemented by the order management module of the system presented with reference to FIG. 9;

FIG. 11 is a schematic representation, in block diagram form, of the operations carried out by the order picker situated at the picking station of the order picking system presented with reference to FIG. 9.

### 6. DETAILED DESCRIPTION OF THE INVENTION

### 6.1. Exemplary Embodiment of the Invention

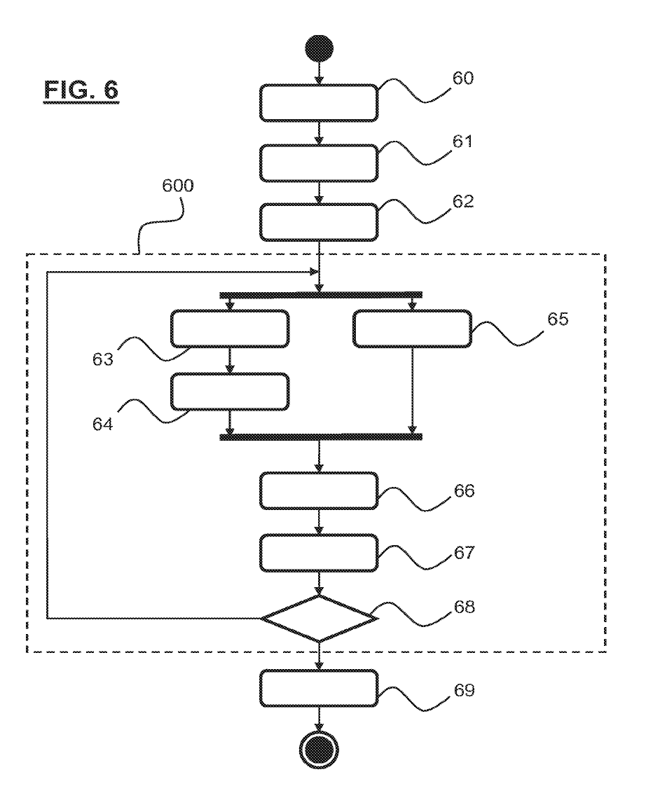

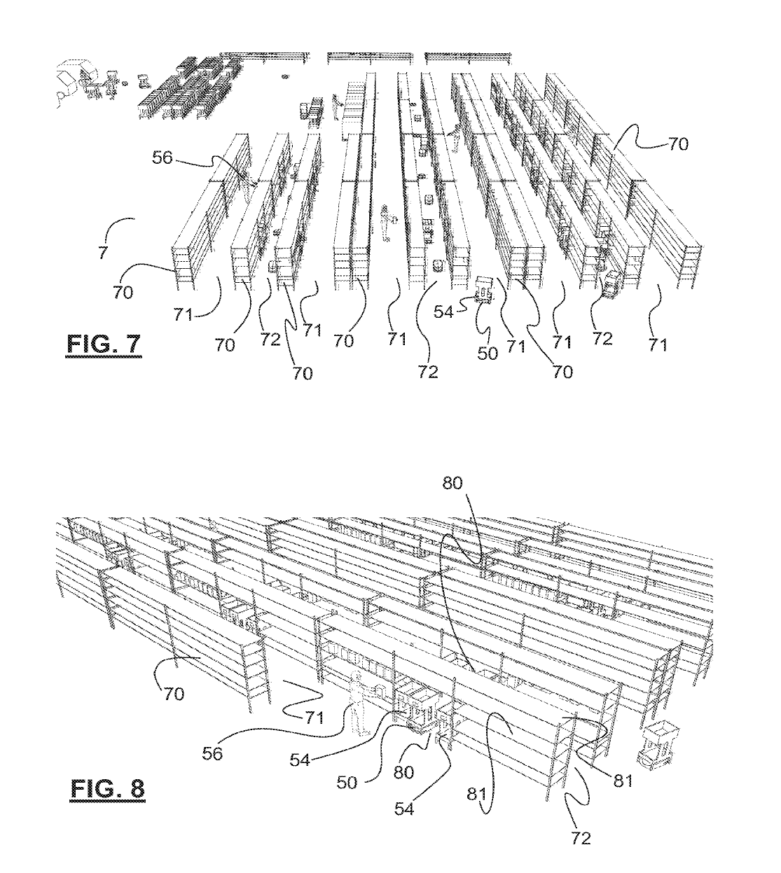

FIG. 5 shows an order picking system 5 which is based on a fleet of motorised mobile units 50, constituted in this particular embodiment of the invention of automatic guided vehicles, a system fleet management 51, a database 52, terminals 53, an order picking management module (not shown on FIG. 5) and containers 54 each equipped with a tray 55 for dropping products placed on a base 58.

The fleet management system 51 controls each mobile unit 50 to move the containers 54 according to the collections to be made and communicates with the terminal 53 to coordinate the collection activity 56 of the order pickers.

To organise a collection, the fleet management system 51 defines a task for transporting a container between a starting position corresponding to its current position and a destination position. The transport tasks are transmitted to the mobile units 50 and the collection points to order pickers 56, by the fleet management system 51 which uses a wireless communication medium 57 with each mobile unit 50 and each terminal 53. This wireless communication medium 57 is for example a communication such as WiFi, WiMAX, IWLAN, GSM, GPRS, UMTS (registered trademarks).

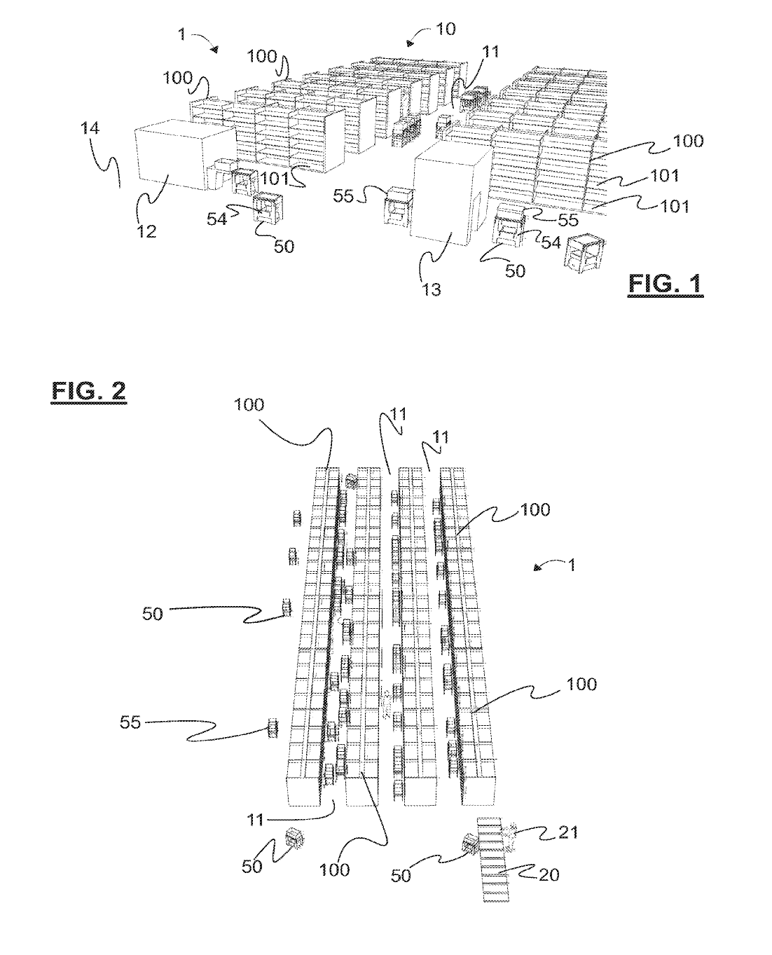

FIG. 1 illustrates a warehouse 1 for storing products for shipping, which is equipped with an order picking system presented with reference to the FIG. 5.

In this warehouse 1, a storage area 10 includes traffic aisles 11, delineated by racks 100 equipped with shelves 101 on several levels. Products or articles are stored on the shelves 101, which are referenced in the warehouse stock management database.

The fleet of motorised mobile units 50 provides transportation of containers 54 in aisles 11 from the warehouse 1, between different points thereof. The warehouse 1 is also equipped with a “cardboard erector” 12, a “cardboard sealing machine” 13 and a temporary storage area 14 on which are placed in a queue waiting for containers 54.

Upon receipt of a new order for one or more item(s) available in the warehouse 1, the order management module transmits to the mobile unit 50 instructions, which are encoded in a radio message, thereby ordering him to get a base 59 of a container 54 not carrying a tray 55 in the area 14 and to transport it to the exit of the conveyor of the erector 12, so that a cardboard tray dedicated to this order, previously shaped by the erector, can be dropped on this base 59.

When the tray 55 is dropped on the base 59, the forming machine 12 sends an end of task acknowledgement message to the order management module and the order management module instructs the carriage 50 to transfer the container 54 in the temporary storage area 14.

Moreover, a location extends freely at the exit of the output conveyor of the forming machine 12, the latter forms then a new tray 55 from a sheet of cardboard.

FIG. 2 shows that the warehouse 1 comprises a preparation area 20 in which an order picker 21 prepares a parcel to be shipped with the products of an order brought made by a mobile unit 50.

To supply this order picker 21, the collection is organised by the fleet management system 51, which directs the mobile units 50 to successively move a container 54 near the locations of the items of the order in the warehouse, so that order pickers 56 who are moving in the aisles 11 can collect each item on a shelf 101 of a rack 100 and deposit it directly in the tray 55 of the container 54.

The steps of an example an order picking method according to the invention are now presented in detail with reference to FIG. 6.

When receiving an order, after having checked the availability of each item ordered, the position of each item available in the store is identified in a first step 60, by looking up the stock management database.

Then, during a step 61, the fleet management system 51 chooses a strategy for collecting items in stock which is to define an order for collecting items, that is to say a way that a container will need to travel to be able to successively deposit each article forming the order. This path includes as many collecting steps, or stopovers, as different items listed in this order. Each stopover corresponds to a collection point near a rack 101 on which an article of the order is stored.

In a step 62, the fleet management system 51 selects a free container near the first collection point.

Then, the fleet management system 51 selects a free motorised mobile unit 50 which it instructs, in a step 63, to fetch the container 54 selected at step 62. For this purpose, the fleet management system 51 chooses among the available mobile units 50, the mobile unit that will have the shortest path or trajectory from its current position to the next collection point via the position of the container 54 to be moved.

In a step 64, the mobile unit 50 carries the container 54 until the next collection point near the item(s) to be collected. Arrived at destination, the mobile unit 50 informs the fleet management system 51. It is then free to carry out a new mission and resumes the process according to the orders transmitted by the fleet management system 51.

At the same time, in one step 65, the system fleet management 51 selects an order picker 56. Advantageously, the collection path programmed for this order picker 56 runs near the collection point, which limits its travels.

Once the container 54 is delivered at the point of collection, the terminal 53 of the order picker 56 notifies him, in a step 66, a new collection task to be performed at the collection point. Thus, continuously updated information is delivered to the order picker 56. During this step 66, the fleet management system 51 registered in the picking path of the order picker 56, stored in a terminal 53, this new collection point, the associated article and the quantity to be taken.

Then, the operator 56, when he has reached the collection point following the path notified, completes the order by taking off the rack 101 the quantity of items planned on his terminal 53 and places it in the tray 55. The order picker 56 then completes this picking task by notifying the completeness thereof using its terminal 53, by informing (step 67) the order picking management module of the fact that the quantity of desired articles has been laid in the target container 54. Then, the order picker 56 continues its collection path to the next scheduled collection point.

The order picking management module checks then the order (step 68) for completeness.

The set of steps 63 to 68 form a collection step 600 at a specific position (also called collection point) of at least one item of the order.

If for the order picking management module, all the items composing the order were collected at the step 68, then we chain through a step 69, if not the collection management step 600 is reiterated with a new item of the order that has not been collected yet.

Finally, during step 69, the fleet management system 51 completes the preparation of the order by instructing the transfer of the container 54 in which the items of the order have been dropped to a shipping station, comprising the cardboard closing machine 13, to finalise the packaging and prepare the delivery of the order. During this step, a free motorised mobile unit 50 is selected. It receives an instruction from the fleet management system 51 to fetch the container 54 at the last collection point to transport it to the shipping station.

It should be noted that the parking spaces of the containers 54 are not limited. Thus, it is possible to pre-position containers nearby and as close to the sampling location of a product, which dispenses the order pickers 56 from transporting products.

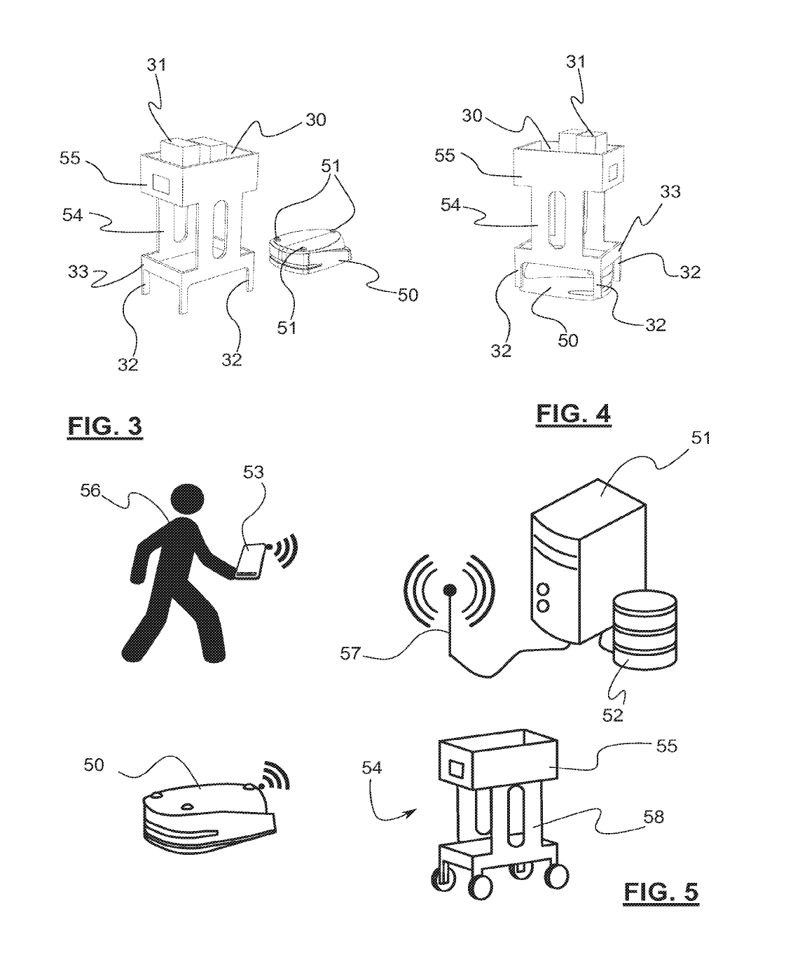

FIG. 3 illustrates a motorised mobile unit 50, which is a lightweight mobile robot powered by a battery, able to move autonomously in the warehouse 1 and carry light loads. This mobile unit 50 receives instructions to move from the fleet management system 51 and sends it data concerning its position, via a wireless communication module 57. This mobile unit 50 is also able to avoid collisions with still or mobile obstacles, like other mobile units, containers 54 are placed on the ground, or order pickers 56 that move in the aisles 11 of the warehouse 1.

The mobile unit 50 comprises three studs 51 forming a plane which is substantially parallel to the ground, for carrying a load. Preferably, this plane is substantially horizontal. It is mobile vertically between a low position and a high position for transporting the load. The vertical displacement of the plane to lift the load is ensured by lifting means, not shown. These vertical lifting means are for example electric cylinders.

In this FIG. 3, it can also be seen that the mobile unit 50 approaches a container 54. The container 54 comprises a storage tray 55, wherein the order picker 56 has easily placed items 31, thanks to a base which raises the tray 55, at the working height of the operator 56 when the latter is standing. Thus, the order picker 56 does not need to lean forward or to bend to drop items 31 in the internal volume 30 of the storage tray 54.

We also note that the base of the container 54 comprises feet 32 and a base 33 raised above the ground. Thus, the mobile unit 50 which is in low position, can slip between the feet 32 under the base 33. Then the mobile unit 50 raising the container into the upper transport position with lifting means, as shown in FIG. 4 for a new destination based on orders or commands received from the fleet management system of mobile units.

### 6.2. Other Exemplary Embodiments of the Invention

FIG. 7 has illustrated another example of a warehouse equipped with an order picking system 5 according to the invention based on a fleet of motorised mobile units 50 carrying containers 54.

In this particular embodiment of the invention, the racks 70 of a storage area 7 delineate aisles 71 for moving order pickers 56 and counter-aisles 72, reserved for moving mobile units 50. Thus, the crossings and risks of collisions between the operator 56 and the mobile units decrease, which requires less vigilance from the operators 56 and reduces stress and fatigue of the latter.

To allow delivery of a container 54 near the collection point, reservations 80 have been arranged in the lower portion of the racks 70 below the shelves 81, distributed every 15 to 20 metres in the storage area 7 of the warehouse.

These reservations 80 can park containers 54 inside the shelves.

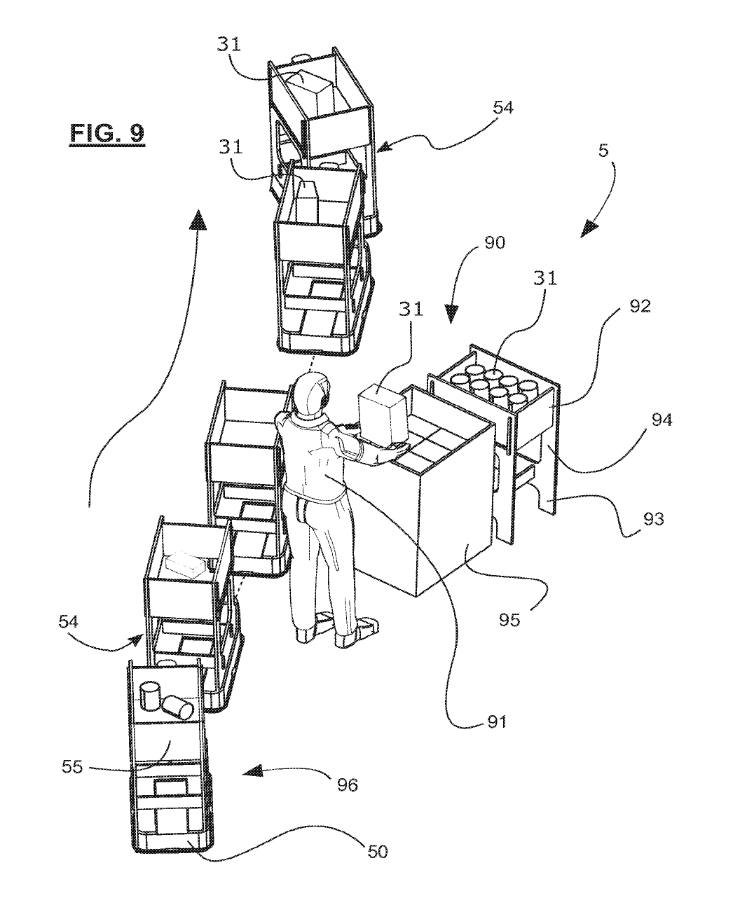

FIG. 9 illustrates a preparation station 90 of an order picking system 5 according to the invention close to which motorised mobile units 50 carrying containers 54 of order being picked up, are parked in a queue.

The task of the operator 91 is to distribute the articles 31 of the same reference in the containers 54 which are presented to him by mobile units 50 parked in a queue 96. For this, he can take items 31 on a pallet 95 in a tray 92 placed on a base 93.

In a variant, it is a robotic arm that can take the items 31 on the pallet 95 or in the tray 92, and drops them as the motorised units 50 are fed forward into the trays of the containers 54 within reach.

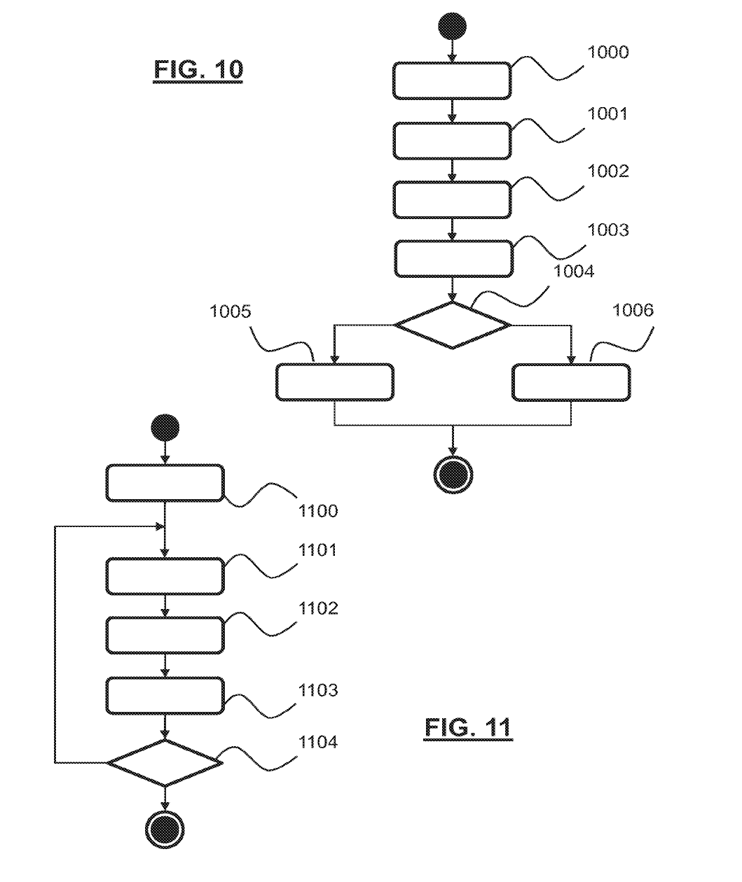

FIG. 10 is a schematic representation, in block diagram form, of the steps of a method for order picking management implemented by the order management module of the system presented with reference to FIG. 9.

In a first step 1000, the terminal 53 transmits to the order picking management module, the reference number of the product 31 stored on the pallet 95 or on the container 94, which was previously entered by the operator 91 on the terminal 53, or obtained by reading the barcode of the item 31 using the terminal 53.

When it receives the reference number of the product 31 to be distributed among various orders, the order picking management module looks for each command to be completed with the product 31 (step 1001).

Then, during a stage 1002, the order picking management module plans for each of these orders, transport instructions so as to synchronise the movement of the containers 54 with the order picker's movement 91 in order to distribute the items 31.

Specifically, the order picking management module allocates to each order including the product 31, the identifier of this product 31 as well as the amount required for that order. It orders then, through the fleet management system, to a mobile unit 50 available to pick up the container 54 corresponding to this order, which is parked in the waiting temporary storage area 14, and to transport it to the queue 96, then to be present within reach of the operator 91 at the preparation station 90, by following the feeding order of the mobile units 50 in the queue 96.

Then in a step 1003, the order picking management module waits to receive from the terminal 53, a confirmation message that the required quantity of items 31 was dropped in the tray 93, following the validation of this operation by the operator 91 on the terminal.

When the quantity of items 31 demanded has been added to the container 54 and confirmed, the order picking management module checks (step 1004) whether the corresponding order is complete to proceed to step 1005, or if other items 31 are expected and go to step 1006.

When the order is complete, the order picking management module transmits instructions to the mobile unit 50 for conveying the container 54 to the cardboard sealing machine 13 (step 1005).

If the order is incomplete, then the order picking management module instructs the mobile unit 50 to drop the container 54 in the temporary storage area 14 (step 1006).

The different operations performed by the operator 91 at the picking station are illustrated in a synoptic way on FIG. 11, in diagrammatic form.

In a first step 1100, the terminal 53 requests the operator 91 to identify the items 31 to be distributed between the various order by inputting at a terminal keyboard 53 the product reference, or by reading the barcode of the item 31 using the terminal 53.

In step 1101, a message on the screen of the terminal 53 requests the operator 91 to identify the container 54 that the mobile unit 50 presents, by reading a barcode inscribed on the container. The terminal 53 transmits this identifier to the order picking management module which transmits back, in a step 1102, the number of products 31 to be added to the container 54, so that the terminal 53 displays it for the operator 91.

Thus, the operator 91 completes each order associated with a container 54, with the quantity of items 31 displayed by the terminal 53, at the request of the order picking management module.

In a next step 1103, the operator 91 uses the terminal to confirm that the operation is complete. The confirmation message validated by the order picker is retransmitted by the terminal 53 to the order picking management module which assigns new instructions to move to mobile unit 50 which leaves the order picking station 90 with the container 54.

In the optional step 1104, the terminal 53 queries the operator 91 to ensure that there are other items 31 of the same reference in stock on the pallet 95 and/or in the tray 92.

If the order picker confirms that there are remaining items 31, operations are resumed at step 1101, with a new container 54 of a different order.

If the stock of products 31 on the pallet 95 and in the tray 92 has been exhausted, a pallet of a new product or the same product 31 and/or another container loaded with this new product or item 31 and the order picker resumes the operations at step 1100.

In the case where step 1104 is not implemented, the order picker resumes at step 1103 as long as the terminal does not indicate that all the orders to be completed with the product 31 have not been processed. For this purpose, it is the order picking management module that counts the quantity of products taken from the pallet and the tray and the residual quantity thereon.

### 6.3. Other Optional Features and Advantages of the Invention

In variations of the embodiments of the invention detailed above, it may also be provided:
to implement a parallel collection strategy to increase the speed of picking items, for example, by dividing the warehouse into zones, and partitioning the order based on the position of the items in the warehouse. For each zone in which at least one article of the order is stored, a collection path of a container is then defined;
to implement a multi-order collection strategy per zone, in which the same container used for the collection of items from various orders stored in the same area of the warehouse. Then, in a preparation zone, order pickers sort and gather the products of the same order, for shipment;
to jointly carry out the steps of selecting a container or mobile unit;
to select a container 54 on the following criteria: the container that is closest to a free mobile unit or located in a parking area;
to delay the mobile unit under the base 58 long enough for the task of collecting and dropping items in the tray at the collection point is complete;
to provide the collection information to the order picker via a voice command;
to display the collection information on the container;
to divide the internal volume of the container tray to allow storage and/or sort of products and items, by category and/or by orders;
to equip the base of the container with wheels, to allow the order picker to move in the aisle to prepare the order, then to place it on a transit area for example at the end of a shelf. When a mobile unit detects the presence of a packaging unit in this transit area, it takes charge of it, i.e. it identifies it, lifts it and transports it to a new destination;
to provide the operators and/or the order pickers with a terminal for reading barcodes and transmitting them to the order picking management module, to enable the identification of products and/or containers, trays and pallets;
to identify the order containers, the shelves and/or trays of single reference products with an RFID chip (acronym for “Radio Frequency IDentification”) and equip each order picker with a terminal equipped with a RFID tag reading function:
to equip each mobile unit with weighing means intended to measure the mass of a container transported by the mobile unit;
to automatically send, via the mobile unit, a confirmation message that a product of an order, and more generally all the products of an order, have been dropped in the tray of a container by controlling the mass of the container using the aforementioned weighing means.

An exemplary embodiment of the invention remedys the shortcomings of the state of the art mentioned above.

Specifically, An exemplary embodiment of the invention provides an order picking technique which limits the movements of the order pickers and which saves time when preparing an order.

An exemplary embodiment of the invention provides an order picking technique which does not require the order pickers to know the location of each product in the stock.

An exemplary embodiment of the invention also provides an order picking technique that is simple to implement and inexpensive.

An exemplary embodiment of the invention provides an order picking technique that can easily adapt to a reorganisation in the warehouse.

An exemplary embodiment of the invention provides an order picking technique that is safe for order pickers working in the aisles of the warehouse.

An exemplary embodiment provides an order picking technique that allows an operator to distribute identical products between different orders at a high rate.

Although the present disclosure has been described with reference to one or more examples, workers skilled in the art will recognize that changes may be made in form and detail without departing from the scope of the disclosure and/or the appended claims.

1. An order picking system comprising:
a plurality of motorised mobile units able to carry containers for receiving one or more products of an order dropped in them by an order picker,
wherein said containers have a single product dispensing tray mounted on a base configured so as to elevate the tray at least 60 cm, the base comprising an interlock with the mobile units and a ground support.

2. The order picking system according to claim 1, wherein said base has a housing configured to allow one of said mobile units to fit under said container.

3. The order picking system according to claim 1, wherein said ground support comprises at least 2 feet.

4. The order picking system according to claim 1, wherein a unique identifier is associated with each of said containers and in that said mobile units each comprise means for reading said identifiers.

5. The order picking system according to claim 1, wherein said base is equipped with at least two wheels and/or at least two shoes so as to move said containers on the ground.

6. The order picking system according to claim 1, wherein said mobile units each comprise an automatic guided vehicle having at least three rolling wheels.

7. The order picking system according to claim 1, further comprising at least one reservation extending to the ground, formed in a product storage rack, for receiving at least one of the containers.

8. The order picking system according to claim 1, further comprising a fixed order picking station enabling an operator to collect the products of an order in said containers transported to the order picking station by the motorised mobile units and place them in a parcel to be shipped.

9. The order picking system according to claim 1, wherein at least one of said containers is formed at least partially of a cardboard package of a parcel to be shipped.

10. The order picking system according to claim 1, further comprising a fleet management module configured to control commands of movement of mobile units taking into account either a-position of mobile units, or simultaneously the position of said mobile units, a position of the containers and a location in stock of a product of the order to be collected.

11. The order picking system according to claim 1, further comprising a temporary storage area of at least one of said containers.

12. A method comprising:
preparing at least a portion of an order using a plurality of containers and motorised mobile units, said containers having a product deposit tray mounted on a base, which raises said tray by at least 60 cm, and an interlock with the mobile units and ground support wherein preparing the orders comprises the following acts:
a) selecting a product of said portion of the order to be picked;
b) selecting a container;
c) selecting a mobile unit, comprising calculating for each of the mobile units of a distance to be travelled from the mobile unit's current position to a predetermined position near the ordered product, via a position of the selected container, and comparing the calculated travel distances in order to identify the mobile unit to which the travel distance is minimal, that is selected;
d) transporting the container selected by the mobile unit in act c) to the predetermined position near the ordered product;
e) notifying an order picker to deposit a number n (n≥1) of copies of the ordered product in the selected container;
f) an order picker dropping n copies of the ordered product in the tray of the container;
g) if said order portion comprises a plurality of different products, successively selecting other products of said portion of order and performing acts b) to f) for the other products of said order portion;
h) selecting a mobile unit, comprising calculating for each of said mobile units a distance to be travelled from the mobile unit's current position to a fixed picking station or an automatic cardboard sealing station and comparing the calculated route distances so as to identify a mobile unit for which the travel distance to the picking station or the automatic cardboard sealing station is minimal;
i) transporting the container selected by said mobile unit in act h) to the order picking station or the automatic cardboard sealing station.

13. The method for preparing an order according to claim 12, wherein said predetermined position near said ordered product is located in an aisle between two racks.

14. The method for preparing an order according to claim 12, wherein during the transporting act d) or i), the selected mobile unit circulates, at least during a portion of the duration of said transporting step, in a counter-aisle, parallel to an aisle which an order picker is situated, between two racks for storing products.

15. The method for preparing an order according to claim 12, wherein that during the transporting act d) or i), the selected mobile unit circulates, for at least a portion of the duration of said transporting step, under and/or through a rack.

16. The order picking system according to claim 1, wherein said containers have a single product dispensing tray mounted on a base configured so as to elevate the tray at least 80 cm.

17. The order picking system according to claim 3, wherein said ground support comprises at least 3 feet.
